(19) United States
(12) Patent Application Publication
(10) Pub. No.: US 2005/0025926 A1
(43) Pub. Date: Feb. 3, 2005

(54) Power glue strips

(76) Inventors: Peter B. Risi, Brantford (CA); David M. Hacker, Toronto (CA); Brian R. White, Etobicoke (CA)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/812,296

(22) Filed: Mar. 29, 2004

Related U.S. Application Data
(60) Provisional application No. 60/458,498, filed on Mar. 28, 2003.

(51) Int. Cl. B32B 9/00

(52) U.S. Cl. 428/40.1

(57) ABSTRACT

An adhesive product includes a backing strip of release material, and a gelled adhesive on the backing strip. A method of adhering a first object to a second object includes the steps of: providing an adhesive product including a backing strip of release material and a gelled adhesive on the backing strip, applying the adhesive product to the first object such that the gelled adhesive contacts the first object, removing the backing strip from the adhesive product, and pressing the second object against the gelled adhesive and the first object.

### CROSS-REFERENCE TO RELATED APPLICATION

This application claims the benefit of U.S. provisional application Ser. No. 60/458,498, filed on Mar. 28, 2003.

### BACKGROUND OF THE INVENTION

This invention relates in general to adhesives, and in particular to a unique wood adhesive that greatly enhances the benefits for the consumer over existing, competing products.

Existing carpenter's and wood glue comes in a liquid form and is an excellent adhesive in terms of strength. In fact, when properly applied and cured, the liquid wood glue will form a joint stronger than the wood itself.

While the strength of the current products available is adequate, the inherent problems or concerns are many. Firstly, the liquid glue manufacturers indicate that most consumers do not apply the proper amount of glue to the materials, usually over-gluing as it is perceived that more is better (stronger). This could not be further from the truth as over-gluing results in a weaker joint. Further, there is always seepage or oozing that must be cleaned with warm water immediately as the glue will fuse to the wood and seal it. Once this occurs, paint and stains will not penetrate the wood and the finished product will be ruined. Additionally, the amount of time needed to brush on or spread the liquid is excessive and a challenge and usually results in even a greater mess.

When the materials have the liquid glue affixed and are brought together, a form of hydroplaning takes place making clamping, nailing or screwing difficult and tedious. One of the greatest concerns is the cure time for liquid wood glue which takes up to 24 hours for a full cure. Essentially, this means that the material(s) cannot be worked with (sanded, cut, shaped) for at least a full day. This wasted or down time is truly an unwelcome hindrance to any do-it-yourselfer or serious wood worker, professional or hobbyist. In view of the problems associated with current glues, it would be desirable to provide a new adhesive product that avoids these problems.

### SUMMARY OF THE INVENTION

This invention relates to an adhesive product comprising a backing strip of release material, and a gelled adhesive on the backing strip.

The invention also relates to a method of adhering a first object to a second object comprising: providing an adhesive product including a backing strip of release material and a gelled adhesive on the backing strip, applying the adhesive product to the first object such that the gelled adhesive contacts the first object, removing the backing strip from the adhesive product, and pressing the second object against the gelled adhesive and the first object.

Various objects and advantages of this invention will become apparent to those skilled in the art from the following detailed description of the preferred embodiment, when read in light of the accompanying drawing.

### BRIEF DESCRIPTION OF THE DRAWINGS

FIG. 1 is a side cross-sectional view of an adhesive product according to the invention applied to a first piece of wood.

### DETAILED DESCRIPTION OF THE PREFERRED EMBODIMENT

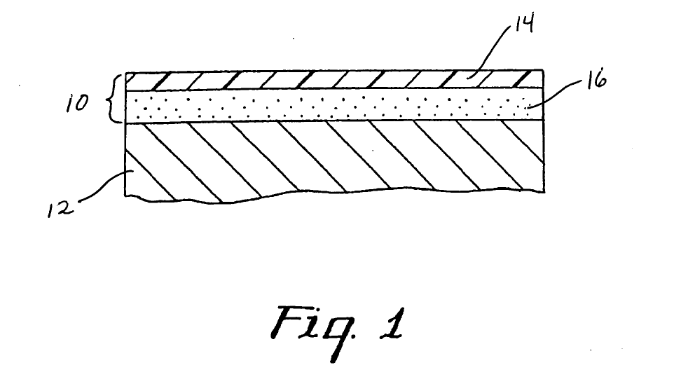

Referring now to the drawings, there is illustrated in FIG. 1 a preferred embodiment of an adhesive product 10 according to the invention. The adhesive product has been applied to a first piece of wood 12, in preparation for joining a second piece of wood to the first piece.

The adhesive product includes a backing strip 14 of release material. The release material can be any type of material(s) that will release from the gelled adhesive when it is pulled away from the adhesive. For example, the release material can be a low-friction material, such as nylon or Teflon®. The release material can also be any suitable material that is coated with a release agent or a low-friction material. For example, the release material can be a strip of plastic or paper that is coated with silicone or wax.

The release material can have any dimensions suitable for applying the desired amount of adhesive to an object. In one embodiment, the adhesive product 10 is in the form of a tape, and the backing strip is in the shape of an elongated strip. For example, the strip may have a width between about ½ inch and about 1½ inches, and typically about ¾ inch.

The adhesive product also includes a gelled adhesive 16 on the backing strip. Any type of gelled adhesive having the desired properties can be used. The gelled adhesive includes an adhesive component, typically an adhesive resin. Any suitable adhesive resin can be used. In a preferred embodiment, the adhesive resin is a poly(vinyl acetate)-based resin in latex form, such as Vinac® XX-240. The gelled adhesive can contain any suitable amount of the adhesive resin, usually between about 40% and about 80% by weight of the adhesive, and typically about 60%.

The gelled adhesive can be gelled in any suitable manner, typically by including a gelling agent in the adhesive. Any suitable gelling agent can be used. For example, the gelling agent can be a high molecular weight cellulosic material having suitable thickening properties. The gelling agent can also be a polymer capable of complexing with salts in water. Examples of gelling systems of this type include polyvinyl alcohol mixed with boric acid or a salt of boric acid, and polymers containing acid groups capable of complexing with divalent salts.

In a preferred embodiment, the gelling agent is a gelling colloid. More preferably, the gelling agent is a combination of colloidal silica and an electrolyte. This system has shear thinning properties such that it builds to a jelly-like consistency and it breaks down to a liquid consistency when rubbed between the fingers. This system may also provide improved adhesion. Any suitable type of colloidal silica can be used. For example, the Ludox® brand colloidal silicas from Grace-Davison can be used. The gelled adhesive can contain any suitable amount of the gelling colloid, usually between about 10% and about 30% by weight of the adhesive, and typically about 20%.

Any suitable electrolyte(s) can be used in combination with the colloidal silica. For example, the electrolytes may be selected from the group of sodium tripolyphosphate, potassium tripolyphosphate, tetrapotassium pyrophosphate, magnesium chloride, sodium carbonate, sodium chloride, and sodium carboxymethyl cellulose. In a preferred embodiment, the electrolyte is one of the phosphate electrolytes, most preferably potassium tripolyphosphate. The gelled adhesive can contain any suitable amount of the electrolyte, usually between about 0.5% and about 5% by weight of the adhesive, and typically about 2%. For example, the adhesive may contain about 20% of a solution of potassium tripolyphosphate (10.9% in water).

In a preferred embodiment, the gelled adhesive also includes a coalescing solvent. The incorporation of the coalescing solvent may improve the integrity and strength of the gelled adhesive as well as lowering its surface tension. Any suitable type of coalescing solvent can be used. For example, some suitable solvents may include propylene glycol n-propyl ether, dipropylene glycol methyl ether, and propylene glycol methyl ether. The gelled adhesive can contain any suitable amount of the coalescing solvent, usually between about 2% and about 12% by weight of the adhesive, and typically between about 5% and about 9%.

The incorporation of polyvinyl alcohol in the gelled adhesive may improve its “green” strength, or its ability to hold a joint in position while the adhesive sets. The gelled adhesive can contain any suitable amount of the polyvinyl alcohol, usually between about 2% and about 15% by weight of the adhesive, and typically between about 5% and about 7%.

The gelled adhesive can also include one or more additives suitable for use in adhesives. For example, a defoamer can be added to control the formation of bubbles during mixing. A biocide can be added to prevent degradation of the adhesive, particularly if the adhesive contains a latex polymer which is biodegradable. Other possible additives include a humectant and an anti-freeze.

The following composition is illustrative but nonlimiting with respect to the composition of the gelled adhesive:
58.75% Vinac® XX-240 [poly(vinyl acetate)-based adhesive resin]
19.59% Ludox® HS-40 [colloidal silica (gelling agent)]
17.63% KTPP (10%) [potassium tripolyphosphate (electrolyte)]
3.92% Santicizer® 160 [butyl benzyl phthalate (coalescing solvent)]
0.11% Dowicil® 75 [biocide]

The gelled adhesive is preferably at least as strong as liquid glue products used for the same intended application, and preferably it is at least about 10% stronger. In one embodiment, the gelled adhesive has an adhesive strength of at least about 8 Mpa as measured according to British Standard BS EN 205: 1991, “Test methods for wood adhesives for non-structural applications—Determination of tensile shear strength of lap joints”, Annex A, using beech wood as the substrate.

The gelled adhesive is preferably tacky to the touch. The tackiness eliminates or reduces the hydroplaning effect by helping to hold the glued objects in place while preparing for clamping etc. This is a huge benefit to trim carpenters as the adhesive will actually hold trim in place so the carpenter can gather finishing nails, clamps or screws etc. This also helps to keep the adhesive in place, and out of areas, such as detailed trim, where unwanted adhesive is very difficult or impossible to remove without ruining the workpiece.

Most liquid glues allow materials to be moved or adjusted for about 10 minutes before the glue sets firm. These final adjustments are often necessary before any final clamping, screwing or nailing takes place. Preferably, the gelled adhesive sets in a time between about 5 minutes and about 20 minutes, and more preferably between about 10 minutes and about 15 minutes, to allow time for adjustments prior to setting firm.

The gelled adhesive preferably has a reduced cure time compared to liquid glues. For example, liquid wood glues typically have a cure time of about 24 hours. Preferably, the gelled adhesive reaches full cure within about 5 hours, and more preferably within about 4 hours, enabling the user to work with the glued project completely after this time. For any serious hobby or professional wood worker, this is a significant benefit. Waiting for a full 24 hours before touching or working with their project is excruciating and costly. So much so, that many wait only a few hours, hoping that the liquid glue has set enough, but in fact the strength may be less than 50% of its potential after only a few hours.

If the gelled adhesive is used for bonding porous materials, such as wood, preferably the adhesive fully penetrates the material similar to the manner in which liquid glue does. The pressure applied to the materials, after applying the adhesive, assists the adhesive in liquefying and penetrating into the materials.

Shelf life is an important consideration for the consumer and the retailer. Taking liquid glue to a gelled stated poses a problem with the gelled adhesive drying too quickly. Preferably, the shelf life (both packaged and once opened) of the gelled adhesive is at least as long as comparable liquid glues.

The ingredients can be processed in any suitable manner to make the gelled adhesive. Typically, the ingredients are added together and mixed until the desired gel properties are obtained.

The gelled adhesive can be joined with the backing strip to make the adhesive product in any suitable manner. In a preferred embodiment, the gelled adhesive is in the form of a layer of the adhesive on the backing strip. The layer of adhesive can have any suitable thickness. For example, it may have a thickness between about 1/64 inch and about 1/16 inch, and typically about 1/32 inch. The gelled adhesive can be applied to the backing strip in any suitable manner; for example, the adhesive layer can be extruded, spread or sprayed on the backing strip depending on the final formulation. The resulting adhesive product is preferably in the form of a tape. The tape can be rolled up in the form of a conventional roll of tape. Alternatively, the tape can be applied to a release material and then removed from the release material when ready for use.

In use, the adhesive product can be applied as easily as ordinary tape. The consumer simply cuts the tape to the appropriate length required, and applies the adhesive side to the first piece of material to be glued, firmly pressing the tape into place. The tape's width can be pre-measured to fit standard-sized materials to be glued, and the exact, necessary amount of the gelled adhesive can be affixed on the tape. The consumer then simply removes the backing strip, leaving only the adhesive, and presses the second piece of material into place, clamping, screwing or nailing as needed.

Significant benefits are derived from the ease of use of the adhesive product. Virtually no mess is created, meaning no clean up. The chance of a nearly completed project being ruined by missed glue seepage is eliminated. Because of its ease of application, applying the adhesive product will be much quicker than conventional methods, saving time and energy for the user. No brushing or spreading of glue is required, and therefore messy liquid glue does not end up all over the user and the project.

Because the exact, necessary amount of adhesive can be pre-measured and affixed on the backing strip, wastage is eliminated and more importantly, the glued joint will be stronger just by the fact that the proper amount of adhesive has been applied. This also removes any seepage and mess associated with gluing using liquid.

The adhesive product can be used for gluing together any type of materials, such as wood, plastic or metal. In a preferred embodiment, the adhesive product is particularly suited for use as a wood adhesive.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. An adhesive product comprising:
a backing strip of release material; and
a gelled adhesive on the backing strip.

2. An adhesive product according to claim 1 wherein the adhesive is in the form of a layer of the adhesive on the backing strip.

3. An adhesive product according to claim 2 wherein the adhesive layer has a thickness between about 1/64 inch and about 1/16 inch.

4. An adhesive product according to claim 1 which is in the form of a tape.

5. An adhesive product according to claim 1 wherein the adhesive is tacky to the touch.

6. An adhesive product according to claim 1 wherein the adhesive sets in a time between about 5 minutes and about 20 minutes.

7. An adhesive product according to claim 1 wherein the adhesive cures within about 5 hours.

8. An adhesive product according to claim 1 which is particularly suited for use as a wood adhesive.

9. An adhesive product according to claim 1 wherein the release material is a low-friction material.

10. An adhesive product according to claim 1 wherein the release material includes a coating of a release agent or a low-friction material.

11. An adhesive product according to claim 1 wherein the gelled adhesive comprises an adhesive resin and a gelling agent.

12. An adhesive product according to claim 11 wherein the gelling agent comprises a gelling colloid.

13. An adhesive product according to claim 11 wherein the gelling agent comprises a combination of a colloidal silica and an electrolyte.

14. An adhesive product according to claim 13 wherein the electrolyte comprises a phosphate salt.

15. An adhesive product according to claim 11 wherein the adhesive resin is a vinyl acetate-based resin.

16. An adhesive product according to claim 11 wherein the gelled adhesive further comprises a coalescing solvent.

17. An adhesive product according to claim 11 wherein the gelled adhesive further comprises polyvinyl alcohol.

18. An adhesive product according to claim 1 wherein the gelled adhesive has an adhesive strength of at least about 8 Mpa.

19. A method of adhering a first object to a second object comprising:
providing an adhesive product comprising a backing strip of release material and a gelled adhesive on the backing strip;
applying the adhesive product to the first object such that the gelled adhesive contacts the first object;
removing the backing strip from the adhesive product; and
pressing the second object against the gelled adhesive and the first object.

20. A method according to claim 19 wherein the adhesive product is in the form of a tape, and wherein the method comprises an additional step, before applying the adhesive product, of cutting the tape to a predetermined length.
